(19) United States
(12) Patent Application Publication
(10) Pub. No.: US 2026/0319076 A1
(43) Pub. Date: Oct. 15, 2026

(54) LASER RANGE FINDER WITH SIGNAL DIGITIZATION

(71) Applicant: Garmin International, Inc., Olathe, KS (US)

(72) Inventors: Robert A. Lewis, Flagstaff, AZ (US); Joe Ryan Dejmal, Olathe, KS (US); Peter A. Hindman, Olathe, KS (US); Jon M. Seitz, Olathe, KS (US)

(21) Appl. No.: 19/647,280

(22) Filed: Apr. 14, 2026

Related U.S. Application Data
(60) Provisional application No. 63/788,248, filed on Apr. 14, 2025.

(51) Int. Cl. G01S 7/4865; G01S 7/484; G01S 7/487; G01S 17/10

(52) U.S. Cl. CPC G01S 7/4866; G01S 7/484; G01S 7/4873; G01S 17/10

(57) ABSTRACT

A laser rangefinder determines distance by digitizing temporal changes in a received optical signal rather than signal amplitude. An optical transmitter emits a code-sequence-modulated optical burst, and an optical receiver converts a reflected return into an analog signal. A delta modulator samples successive signal values and generates logic states representing differences between adjacent samples to produce a slope-decoded signal record. The slope-decoded signal record is correlated with a reference sequence corresponding to the transmitted code sequence to produce a correlation output representing a derivative of a delayed autocorrelation function. Distance is determined using a zero-crossing of the correlation output following an identified correlation peak.

### RELATED APPLICATION

The present non-provisional patent application claims priority to U.S. Provisional Patent Application Serial No. 63/788,248 filed on April 14, 2025, and entitled “LASER RANGE FINDER WITH SIGNAL DIGITIZATION.” The entirety of the above-identified provisional patent application is hereby incorporated by reference into the present non-provisional patent application.

### BACKGROUND

### 1. Field

The present invention is directed towards waveform digitization associated with the time-of-flight distance measurement and proximity sensing.

### 2. Related Art

Conventional laser range finders typically slide a threshold level through the signal envelope to allow waveform digitization under stronger signal conditions. The transmit burst pattern and a matched time constant receiver filter network effectively slide a detection threshold through the envelope of the received signal during the burst period. Time constants of the filter networks have memory of strong signal events and a period of time after the strong signal reception is needed to recover sensitivity necessary to detect a weaker second signal. This recovery period may be on the order of the transmitted burst length, and can delay accumulation of edge crossings until the threshold returns to within the noise envelope. The saturation of the edge statistics that occur under strong signal conditions effectively compresses the signal response. This signal compression effect means that strong signal will suppress the system’s response to signal returns occurring simultaneously within the burst period of the stronger signal.

### BRIEF DESCRIPTION OF THE DRAWING FIGURES

Embodiments of the invention are described in detail below with reference to the attached drawing figures, wherein:

FIG. 1 is a top-level block diagram for a rangefinder system incorporating edge based signal reconstruction using delta modulator;

FIG. 2A is a graph that illustrates the signal slope and offset due to additive noise with a threshold set at the mean signal point;

FIG. 2B is a table that shows the output states difference between the rising and falling edge determination of prior art methods versus the delta modulator output;

FIG. 3 is a simplified block diagram of a delta modulator using single delay element;

FIG. 4 is a simplified block diagram of a delta modulator using single delay element and window comparator;

FIG. 5 is a wave diagram that shows correlation waveforms for two windowed comparator thresholds;

FIG. 6 is a wave diagram that shows superimposed correlation waveforms for a strong primary return and weaker secondary return at increasing delays;

FIG. 7 is a wave diagram that shows a correlation waveforms for a 50:1 S/N primary return and weak 1:1 S/N secondary return with a 100 meter separation.

FIG. 8 is a wave diagram that shows superimposed correlation waveforms for a weak and strong signal returns with the integration count varied by (S/N)² to normalize peak values.

FIG. 9 is a simplified block diagram that illustrates a delta modulator embodiment consisting of single analog sample-and-hold followed by latched comparator;

FIG. 10 is a simplified block diagram that illustrates a delta modulator embodiment consisting of two high-speed analog sample-and-holds followed by comparator and logic state inverter;

FIG. 11 is a simplified block diagram that shows a digital implementation of the delta modulator using a full resolution A/D converter with digital latch and magnitude comparator;

FIG. 12 is a simplified block diagram that shows an improved delta modulator using A/D converter implementation can capture small signals;

FIG. 13 is a simplified block diagram that shows a shift register based random sequence generator; and

FIG. 14 is a wave diagram illustrating an example of correlation waveforms relating to two seed values for the sequence generator.

### DETAILED DESCRIPTION

This document discloses a method and apparatus to improve the performance of edge sampling detection as applied to correlation based optical distance measurement. In various embodiments, a rangefinder includes an optical transmitter and receiver, circuitry that generates a slope-decoded representation of a received signal (e.g., via delta modulation), and processing circuitry that performs correlation-based delay estimation (e.g., using a zero-crossing of a correlation output). It is an intention of some embodiments of the invention to minimize the suppression of signal sensitivity due to the use of the adaptive threshold and to reduce the impact of signal compression due to a strong signal in close proximity to the second smaller signal.

In overall operation, the rangefinder functions as follows. The transmitter emits a code-sequence-modulated optical burst into the transmission channel toward a target, with the transmitted code sequence being selected by a pattern control signal. An optical signal returning from the target is received by the optical receiver and converted into an analog receive signal. The delta modulator samples the analog receive signal at successive sampling points and produces, for each sampling point, a logic output state representing the sign of the difference in magnitude between the analog receive signal at that sampling point and at the immediately preceding sampling point. The sampler captures the succession of logic output states in timed relation to a clock reference to produce a slope-decoded signal record. The correlation processor correlates the slope-decoded signal record against a stored reference template corresponding to the transmitted code sequence, producing a correlation output representing the derivative of a delayed autocorrelation of the return signal. The delay estimator identifies a zero-crossing of the correlation output following the correlation peak, and determines a range to the target based on the time position of that zero-crossing relative to a reference path delay. Subsequent paragraphs describe particular embodiments and improvements to the foregoing overall operation.

One objective of the disclosed invention is the elimination of the need for a threshold detector with an associated detection reference swept through the signal envelope during the signal burst reception. Previously, either knowledge of the peak signal envelope was necessary to program a series of detection level steps into the threshold detector necessary to fully digitize the signal over multiple signal acquisitions, or a receiver filter network with transient response matched to the transmitted burst followed by a threshold detector was used to effectively sweep a detection level through the extent of the signal envelope during the received burst interval. The elimination of a detection reference driven by the envelope response of a receiver filter network not only removes memory effects associated with strong signal events, but also may enable low-resolution digitization during periods of high signal slew rate. This improves signal reproduction fidelity and enhances the identification of closely spaced target echoes by reducing signal compression and improving side-lobe suppression.

The use of delta modulation is compatible with existing correlation processing methods based on the use of the derivative of the incoming signal derived from edge detection. The delta modulator in its simplest implementation provides single-bit signal indicating the sign of the difference of the magnitude of consecutive samples. In some embodiments, additional edge-interpretation logic is reduced or omitted to convert consecutive logical samples of a one-zero or zero-one transition indicating a falling or rising edge. Delta-modulated digital signal may not indicate a “no edge” or zero state, which does result in increased bit noise in the raw data. In practice this “chatter” does not have a significant impact in the detection performance, since it is present in the low slope regions in the signal pattern which is strongly suppressed by the matched filter behavior of the correlation process.

As used herein, the output of the delta modulator comprises a succession of logic output states, each logic output state corresponding to a respective sampling point and representing the sign of a difference in magnitude between the analog receive signal sampled at that sampling point and the analog receive signal sampled at the immediately preceding sampling point. The succession of logic output states, as captured by the sampler in timed relation to a clock reference, is referred to herein as a slope-decoded signal record. The slope-decoded signal record is produced directly from the delta modulator output without a separate edge-detection stage operating on consecutive logical samples, as no logic is required to interpret a zero-to-one or one-to-zero transition as a rising or falling edge. This direct production of slope information distinguishes the present approach from prior-art edge detectors that derive edge transitions from threshold crossings of an amplitude-digitized signal.

Another possible improvement in performance can be achieved by adding a zero state in addition to the positive and negative rising and falling slope states to indicate a signal slope below a desired threshold. This can be accomplished by windowing the slope information using a pair of comparators with detection thresholds straddling a zero slope baseline. In certain implementations, a positive or negative logic state is output when the slope exceeds the window bounds, and a zero state may be output for slopes within the window. The benefit of an added zero slope state is to improve processing gain at very low signal to noise ratios and smaller side lobes around the correlative peak under strong signal conditions.

A simple implementation of the delta modulator providing just the sign and optionally a zero state of the magnitude difference between signal samples can be extended to provide the signed magnitude with various options in quantization implementations. By providing both the sign and magnitude of the signal samples, a larger dynamic range can be provided before non-linear effects reduce the ability to detect multiple targets in close proximity and the ability to determine relative signal strengths. In some embodiments, providing a coarse quantized magnitude estimate of differences between successive samples can improve correlation pulse shape, including at high signal-to-noise ratios. Non-uniform quantization may also be used to improve the systems large signal behavior with some impact in small signal response.

An analog implementation delta modulator can be implemented using an analog delay line providing an approximately 1 clock cycle sampling delay in the inverting leg of a high-speed digital comparator. The delay can be implemented using a transmission line delay element or a one- or multi-element lumped delay line consisting of LC delay sections. An example implementation uses an R-C low pass network in the inverting leg of the comparator to implement the delay. An RC filter implementation can reduce sensitivity relative to other delay approaches, while offering reduced complexity. The delay line approaches do not require that sampling occur in the receiver front-end, allowing the logic in the processing FPGA or ASIC to sample the signal based on internal clocks with the chip.

Sample-and-hold circuits followed by a comparator whose output is captured synchronously may also provide the delta modulation function. A single sample-and-hold can substitute for the analog delay line on the inverting input of a signal comparator if the sampling of the comparator output is synchronous with the timing of the sample-and-hold. An alternate embodiment uses a pair of sample-and-holds elements to alternately capture the magnitude of the received analog signal out of the receiver. The pair of sample-and-holds can compensate for practical non-ideal behaviors such as timing delay and offsets which can impact the performance of a single sample-and-hold delay network. A clock reference provided by the processing ASIC synchronizes the analog sampling. The alternating sampling may involve inverting the sign of the comparator when the most recent sample is captured by the sample-and-hold on the inverting input of the comparator. A phase-clocked oscillator can be used to multiply the frequency of a lower frequency clock reference from the processor, to minimize radiated noise and potential interference in the receiver.

All digital implementation of the delta modulator can be provided by a high-speed analog-to-digital converter followed by a digital latch and magnitude comparator to compare the previous and present digitized samples. This approach has the flexibility to allow various levels of quantization from the signed difference to multiple uniform and non-uniform bits of quantization. As in the case of the sample-and-hold implementation, a clock is provided from the processor which can be at the sampling frequency or sub-multiple if a phase-lock loop oscillator is provided in the sampler circuitry.

To improve linearity and to suppress correlation side-lobe ripple, the transmitted correlation pattern can be rotated between two or more related correlation sequences to cancel side lobes while still accumulating energy in the central correlation peak. A series of matching sequences can be stored in a memory in the correlator prior to the signal acquisition sequence or transferred with each transmission. The rotating correlation pattern can be accomplished by the use of a tapped digital delay producing a pseudo random (P-N) sequence with different pattern seeds to change the order of the P-N sequence.

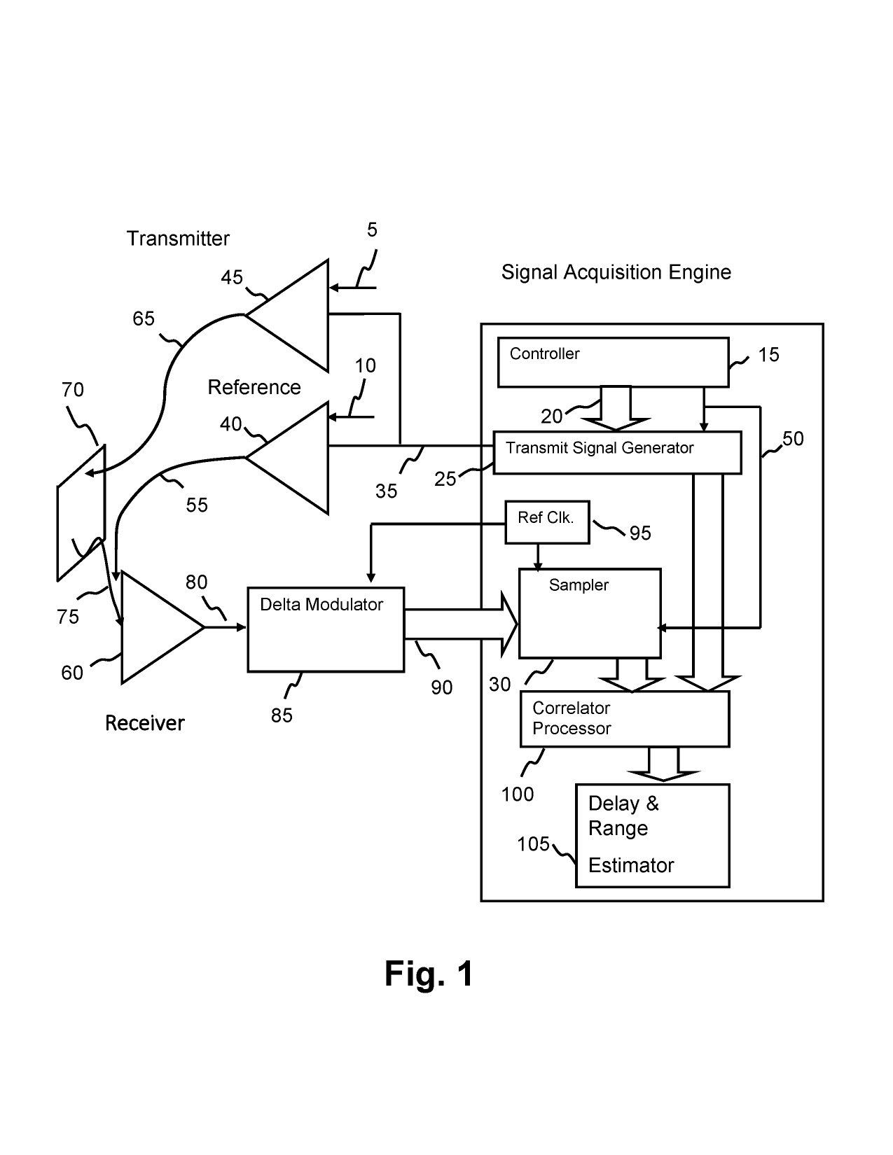

FIG. 1 details a top-level block diagram for a rangefinder system that incorporates delta modulator-based edge detection signal acquisition. Prior to beginning the transmit sequence, control signals 5 and 10 select the transmit drive current for either transmit or reference paths respectively. The controller 15 initiates a signal or reference acquisition through acquisition control signal 20 to the transmit signal generator 25 and signal sampler 30. The acquisition control signal triggers transmit signal generator to produce modulated digital signal 35 which is fed to a pair of optical transmitter components consisting of reference transmitter 40 and external path transmitter 45. The specific transmitted pattern is selected by the pattern control signal 50 which feeds both the transmit signal generator 25 and correlation processor to ensure that the reference pattern used by the correlator matches the transmit pattern. The reference and external path transmitters produce optical signals that are closely matched in delay and waveform shape although the reference channel may produce significantly less optical power than the external transmitter. The propagation path for the reference channel 55 passes directly to an optical receiver 60 through an optical waveguide or through free-space transmission effectively providing a zero-propagation delay reference for the distance calculation. An external beam path 65 terminates on a reflective target 70. A small portion of the signal reflecting off the target 75 is collected by receiver 60. The optical signal entering the receiver is amplified and exits as received signal 80 passing to delta modulator 85. The delta modulator 85 samples the signal value at each sampling time increment and compares the magnitude of the present sample to the previous sample and outputs the sign and optionally the magnitude of the difference. Delta modulator output signal 90 passes to signal sampler 30. The sampler 30 captures the binary state of delta modulator 85 at or at a multiple of a master clock 95. The data transfer may occur at the sample rate or buffered and transferred at a slower rate. Within the correlation processor 100, the sampled delta modulator output from the signal or reference returns is stored. A stored reference template matching the transmitted signal is correlated with the signal return waveform-based edge transitions derived from the signal slope information extracted from the delta modulator 85. The output of the correlation is the derivative of a delayed autocorrelation waveform with the maximum pulse and its following zero crossing point representing signal delay. The delay and range estimator 105 processes the autocorrelation waveform to determine the difference between the round-trip propagation delay time of the received signal and the reference path delay. The time delay difference is used to calculate the distance based on the index of refraction of the signal propagation path.

The mathematical character of the correlation output produced by correlation processor 100 follows from the nature of the delta modulator output 90. Because the delta modulator output 90 at each sampling point represents the sign of the difference between consecutive signal samples, the slope-decoded signal record approximates the sign of the first time derivative of the received analog signal. When this derivative-like signal is correlated against the stored reference template, which corresponds in pattern to the amplitude-domain transmitted code sequence, the resulting correlation function has the mathematical form of the derivative of the cross-correlation between the transmitted pattern and the received signal. In the case of a target return whose received waveform substantially matches the transmitted pattern apart from a propagation delay, this cross-correlation reduces to a delayed autocorrelation of the transmitted pattern, and the output of correlation processor 100 accordingly represents the derivative of a delayed autocorrelation function. The peak of the underlying autocorrelation, which corresponds to the instant of best alignment between the reference and the delayed return, manifests in the correlation output of correlation processor 100 as a change in sign. Accordingly, the location of the autocorrelation peak is determined by identifying a zero‑crossing of the correlation output that occurs after the maximum magnitude of the correlation output. This relationship between the correlation peak location and the zero-crossing location is what permits the delay and range estimator 105 to determine signal delay from a zero-crossing rather than from a peak-search operation.

Delay and range estimator 105 processes the correlation output from correlation processor 100 to determine the time delay of the return signal relative to the reference path. In operation, delay and range estimator 105 first identifies the maximum amplitude of the correlation output within an acquisition window and then identifies a zero-crossing point of the correlation output occurring subsequent in time to that identified maximum, the zero-crossing being used to estimate signal delay. The time position of this zero-crossing point, relative to a corresponding zero-crossing point derived from the reference path signal, is taken as the round-trip propagation delay difference. To achieve range resolution finer than the sampling interval, delay and range estimator 105 may interpolate the zero-crossing position between adjacent samples of the correlation output using linear, parabolic, or higher-order interpolation between sample values straddling the zero-crossing. The time delay difference so determined is converted to a distance measurement using the index of refraction of the signal propagation medium, as previously described.

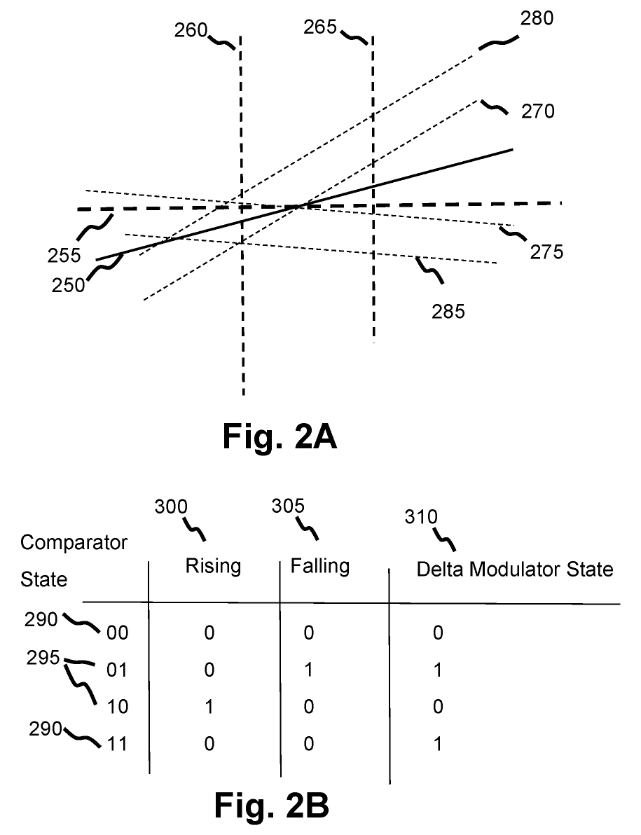

FIG. 2A illustrates an example of the range of signal slope and offset due to additive noise. The signal segment denoted 250 passes through a threshold level 255 straddling the midpoint between two successive time sample points marked by vertical lines 260 and 265. Sloped lines 270 and 275 represent the positive and negative excursions of signal slope respectively due to the impact of additive noise. The signal segments are represented by lines with the assumption that the sample rate is much higher than the Nyquist criteria for the bandlimited signal plus noise. In addition to the slope variations in the signal due to additive noise, there is a potential amplitude offset shown in lines 280 and 285.

FIG. 2B shows an example output of a simple delta modulator, contrasted with prior art methods. Rising or falling edges denoted by 290 and 295 are indicated in columns 300 and 305 by the presence of a one state while no edge transition is denoted as zero. Delta modulator output states in column 310 are distinguished by the output state tends to yield a positive or negative slope determination independent of the initial offset variation. The primary difference between the delta modulator and the comparator derived signal is that the delta modulation output always yields positive or negative slope determination in the stored signal record.

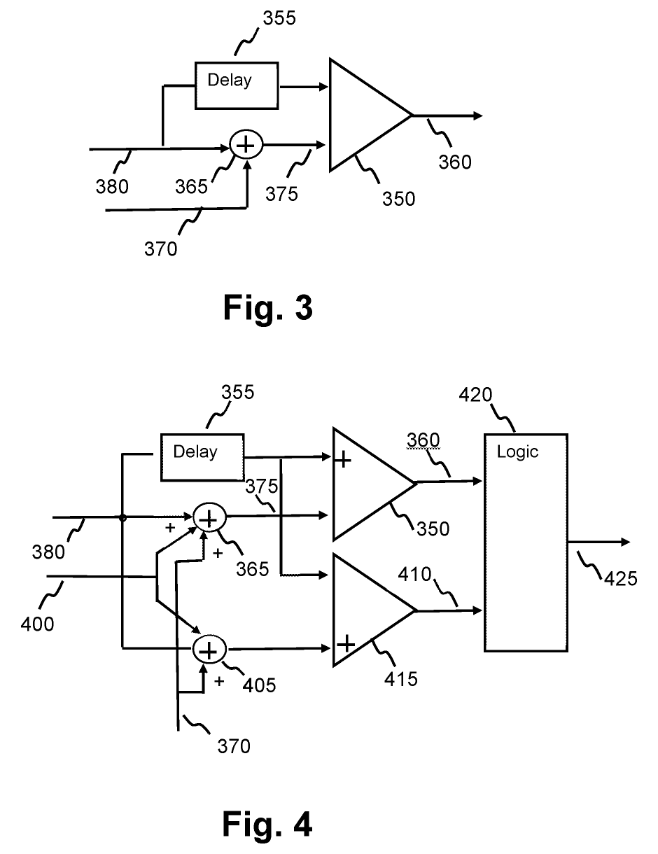

The simplest implementation of the delta modulator yields just the sign of the difference between successive samples. FIG. 3 shows a simplified block diagram of delta modulator consisting of comparator 350 with a delay element 355 to provide a one sampling interval delay on the inverting input of the comparator. DC compensation summing node 365 receives a DC offset signal 370 to maintain the effective differencing threshold centered in the noise envelope during the period between acquisition bursts. Input signal 380 feeds the delay element and dc summing node. The DC compensated signal into the non-inverting comparator input 375 provides the most recent signal sample. DC compensation eliminates any rising or falling edge ratio imbalance due to leakage current and impedance variations between the inverting and non-inverting comparator inputs. A variety of delay element implementations can be utilized from a simple R-C network, single or multiple stages of LC delay elements to a transmission-line-based delay line.

FIG. 4 illustrates another embodiment of the delta modulator using a second comparator to provide a window around a zero-slope level. This allows the addition of a zero-slope signal state reducing random noise in the correlation output and improved central correlation peak fidelity under strong signal conditions. The previous single comparator configuration is modified to provide positive and negative offsets to comparators 350 and 415. Window dead zone offset 400 provides a positive bias through summing node 365 and a negative offset in the added summing node 405. Comparator outputs 360 and 410 are processed by logic 420 to produce output states +1,-1 and zero in the detection output 425.

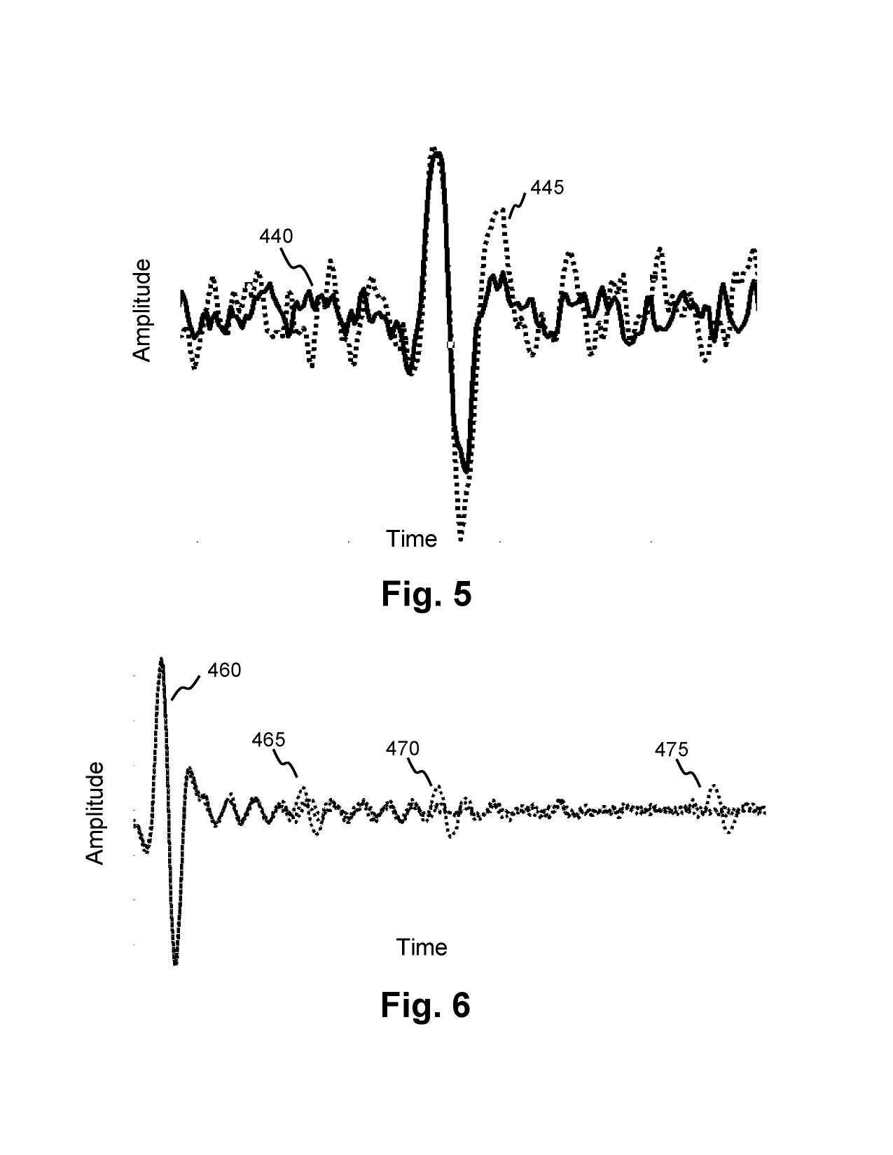

FIG. 5 illustrates the impact of the zero-state window around the zero slope point on the correlation waveform at a low signal to noise ratio of .25:1. In this example the total integration count is 256 using a rotating P-N sequence change every 16 acquisition bursts. The solid trace line 440 shows a correlation waveform resulting from a center dead zone of +/- .5 sigma in relation to the system noise floor. The dotted trace line 445 shows the impact of reducing the dead zone to plus and minus .1 sigma. Although the central correlative peaks are similar, the side lobe ripple outside the central region is substantially higher. Additional simulations indicate the dead zone may be increased up to +/- 1 sigma with minimal negative impact.

In the remaining performance simulations, a dead zone criteria from -.5 to +.5 sigma may be used to force the slope discriminator output state to zero. For slope excursions outside the central zone, slopes with a positive slope are given a value of positive one while a negative value produces a negative one discriminator value.

FIG. 6 shows the superposition of two signal returns. A strong correlation signal at a 100-meter target distance 460 with a signal-to-noise ratio of 10:1 is combined with a second weaker return signal at 125, 150 and 200 meters, labeled 465, 470 and 475 respectively. The weaker return’s signal strength is maintained with an equivalent input S/N of 1:1. The second return correlation amplitude is constant although the second return burst overlays the first with the first with different degrees of overlap. The final case of a primary signal at 100 meters and the second at 200 meters would have no return signal burst overlap since the difference of time delay is approximately 600 nanoseconds which is greater than the burst length of 500nsec. The amplitude consistency between the second returns as they move from overlapping the primary signal to beginning afterwards to indicate that superposition of the two signals does not appreciably compress of the response to the weaker signal.

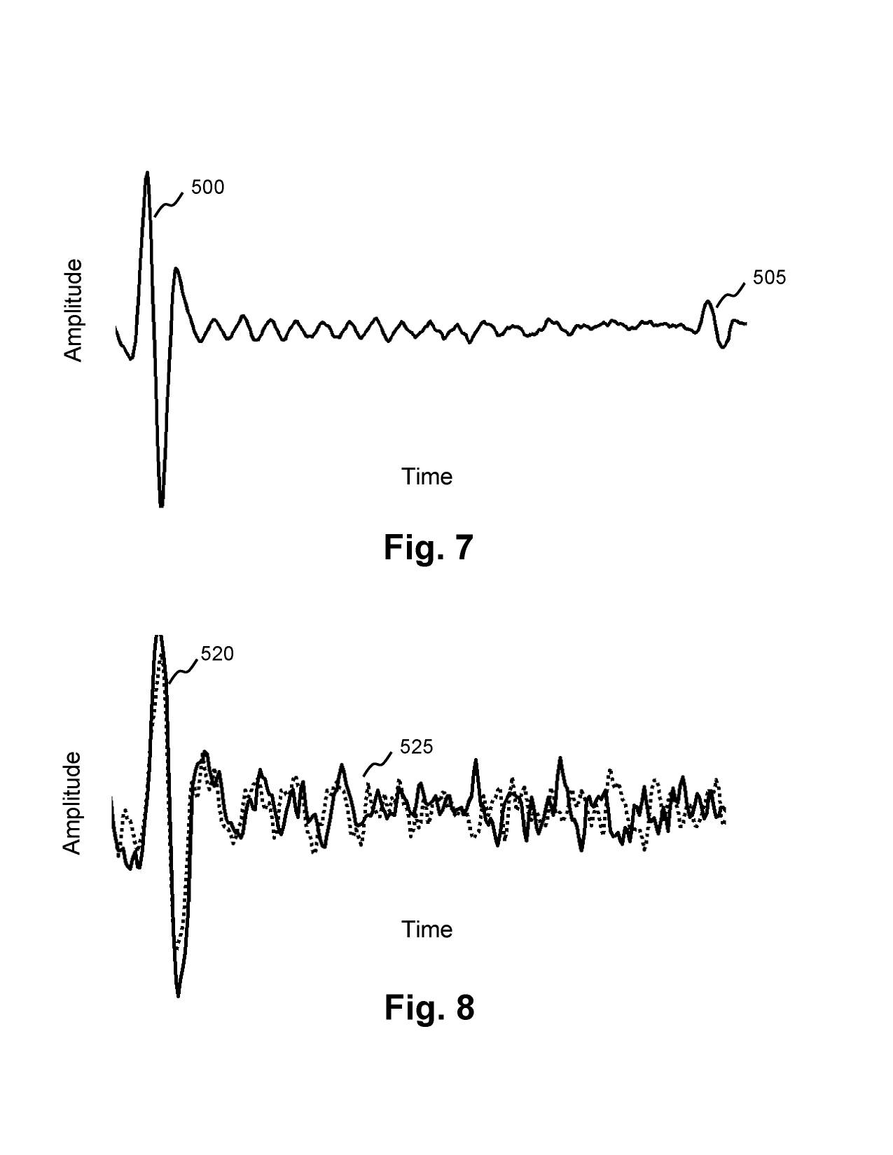

FIG. 7 shows a correlation waveforms for a 50:1 S/N primary return 500 and weak 1:1 S/N secondary return 505 at a 100-meter distance separation.

FIG. 8 shows superimposed correlation waveforms for a weak and strong signal returns with the integration count varied by (S/N) ^2 to normalize peak values. In theory, the required number of signal integration cycles should follow the inverse square of the change in the signal strength. The solid trace line 520 shows the resulting correlation waveform for an S/N ratio of .125:1 and 1024 integrations while the dotted trace line 525 indicates the response for an S/N of 1:1 with sixteen integrations. In this case, the received signal strength and the corresponding signal to noise ratio decreased by 8-fold while the required number of signal integrations increased by 64 times to maintain the same correlation peak to noise ratio. This result indicates that the processing gain follows the theoretical square root of N relationship, where N is the number of average signals. This result is important because it shows that the processing efficiency remains consistent even in the presence of a zero-state window extending from +/- .5 sigma in relation to the input noise floor. The ability to integrate large numbers of pulses to detect very weak signal is an important requirement in many applications where transmitted peak power is limited and the ability to scale average power is practical. In applications using low-cost led based transmitters, where average output power is not limited by laser safety restrictions, range performance can be extended to distances comparable to higher cost laser-based systems.

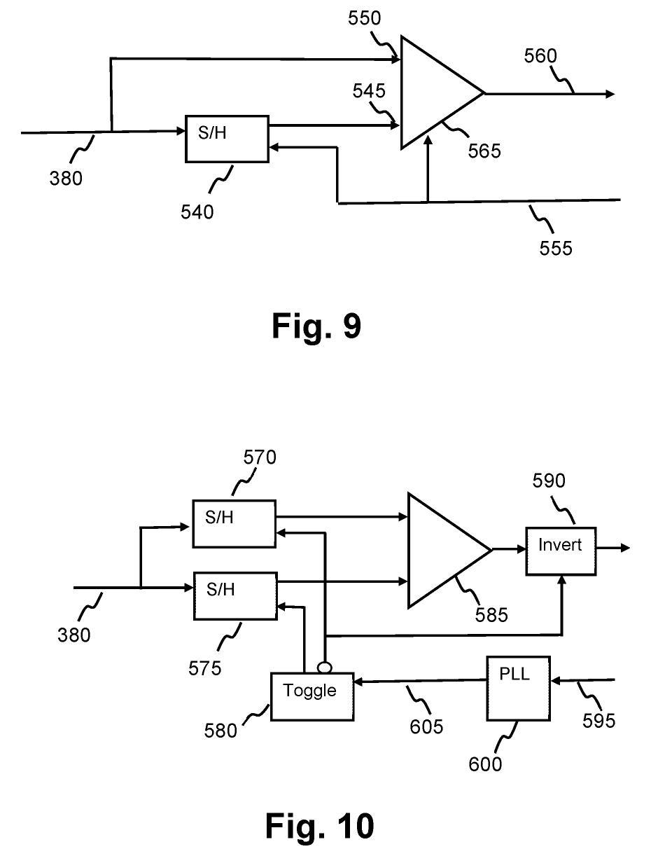

FIG. 9 illustrates a delta modulator embodiment consisting of a single high-speed analog sample-and-hold circuit 540 coupled to an inverting input 545 of a comparator 565. The analog receive signal 380 is applied directly to a non-inverting input 550 of the comparator 565. A sample control signal 555 causes the sample-and-hold circuit 540 to capture a previous value of the analog receive signal, thereby providing a delayed version of the signal to the inverting input 545. The comparator 565 compares the present signal value at the non-inverting input 550 to the delayed signal value at the inverting input 545 and produces an output state 560 representing the sign of the difference between successive samples. The output state 560 is captured synchronously with the sample control signal to produce the delta modulator output. In some embodiments, the effective time sample points between the sample-and-hold and digital latch used to capture the output state of the comparator 565 are equalized.

In another embodiment as shown in FIG. 10 uses two analog sample-and-holds 570 and 575 to store the present and previous amplitude state of the signal input. A toggling logic element 580 alternatively enables each sample-and-hold to sample the signal input with comparator 585 comparing the magnitude of the samples. The sign of the comparator output is alternately inverted by inversion block 590 to account for the alternating storage location of the earliest signal sample. The clock reference input 595 synchronizes the acquisition of the signal samples in the sample-and-holds and optionally latching the output of the comparator 585. A phase locked loop oscillator 600 and output signal 605 can be used to multiply the frequency of the clock reference. The advantage of the use of two sample-and-holds is improved balance between sampling times of alternating samples due to the inherent symmetry between the two sample-and-hold circuits.

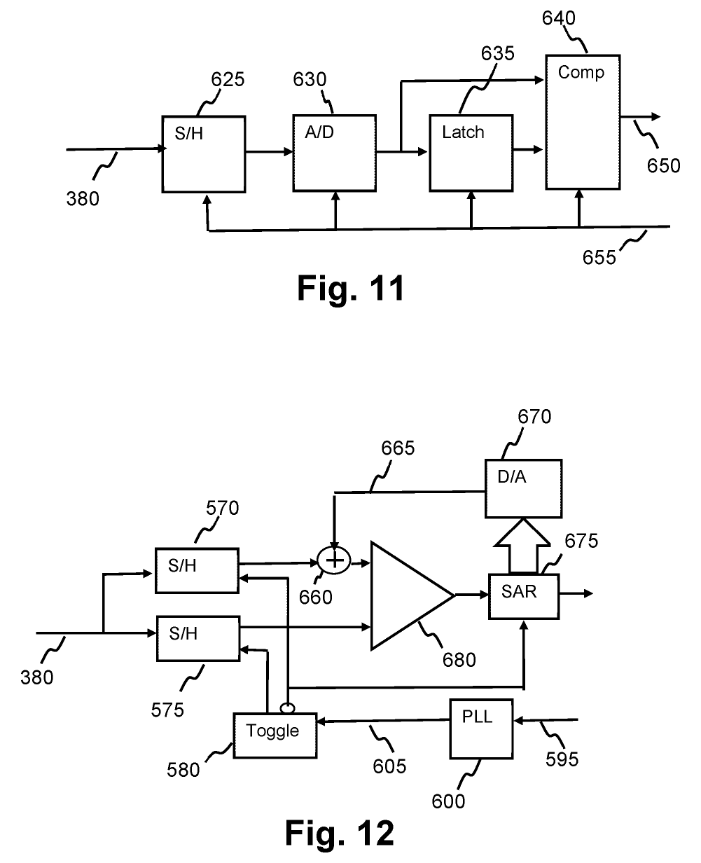

An analog‑to‑digital converter having quantization steps on the order of the root‑mean‑square amplitude of the input noise floor allows a delta modulator to capture edge transition data across the waveform while preserving sensitivity to small signals. A digital implementation of the delta modulator shown in FIG. 11 allows the capture of both the sign and magnitude difference of successive samples. An input sample-and-hold 625 stores the analog input value at the beginning of each sampling interval. An analog-to-digital converter 630 converts the sampled value into a digital value and the digital output is compared with the previous sampled valued stored in latch 635 by a digital magnitude comparator 640. The output 650 of digital magnitude comparator 640 is the magnitude difference between samples and is passed out to the signal acquisition engine for correlation processing. The magnitude may be represented by just the state of the sign or with additional magnitude information. Sampling signal 655 synchronizes the sampling and magnitude determination. The analog-to-digital conversion may be implemented using successive approximation or using pipelined architecture. A disadvantage of this approach is the need to use full resolution A/D to cover the required dynamic range with a sufficiently small quantization step to properly capture small signal. In some embodiments, a quantization step on the order of the RMS noise amplitude helps capture small signals embedded in noise.

Another delta modulator embodiment is shown in FIG. 12 that employs a digital‑to‑analog converter having a sufficiently fine quantization step to resolve changes between successive signal samples without requiring the digital‑to‑analog converter to span the full dynamic range of the input signal. In this embodiment, the twin sample‑and‑hold configuration is modified by introducing a summing node 660 at an input of a comparator 680, the summing node receiving a bipolar compensation signal 665 generated by the digital‑to‑analog converter 670. The D/A converter 670 is used to cancel the amplitude offset between successive signal samples stored in the two sample-and-holds. A successive approximation register (SAR) 675 feeds digital control values to D/A converter 670 based on higher rate comparator samples. Under small signal conditions, D/A converter 670 reaches accurate digital value at the output using standard successive approximation techniques. The multiple sub-clock cycles to reach the required approximation accuracy are typically implemented using asynchronous time steps nominally a multiple of the sampling signal provided by the on-board oscillator supporting the synchronous circuitry. Under large signal conditions where D/A converter 670 does not have sufficient dynamic range to follow the signal, the SAR 675 cannot reach a valid digital approximation and the output value saturates without signal difference cancelation. Saturation of the digital value does not impact the ability of the circuit to continue following the signal however since the successive signal samples are stored in the sample-and-holds not based on the compensation value output of the D/A. Without any SAR activity the SAR 675 output would just reflect the sign of the signal differences as in the previous embodiment.

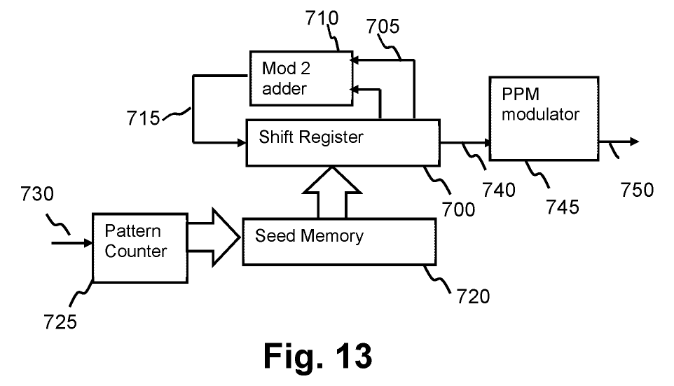

FIG. 13 shows a shift register based random sequence generator with the ability to change correlation sequences. Shift register 700, shift register taps 705, modulo 2 adder 710 and shift register input 715 make up a pseudorandom PR generator that produces maximum length sequences that produce desirable autocorrelation functions. The output 740 then feeds a PPM sequence modulator 745 that concatenates the code with a two slot PPM modulation at twice the rate or more of the PR generator. The final coded output 750 feeds the laser or LED transmitter with the correlation sequence. Seed memory 720 changes the initial state of the shift registers to allow the generation of various PR sequences with comparable central correlation behaviors, but with side-lobe ripple which cancels other sequences. Pattern counter 725 changes the seed value with changes initiated by controller signal 730. The use of a series or correlative signal patterns accumulated in the correlation memory allows improved side-lobe cancelation outside the central correlation peak and rejection of foreign signals due to other ranging units or to intentional jamming.

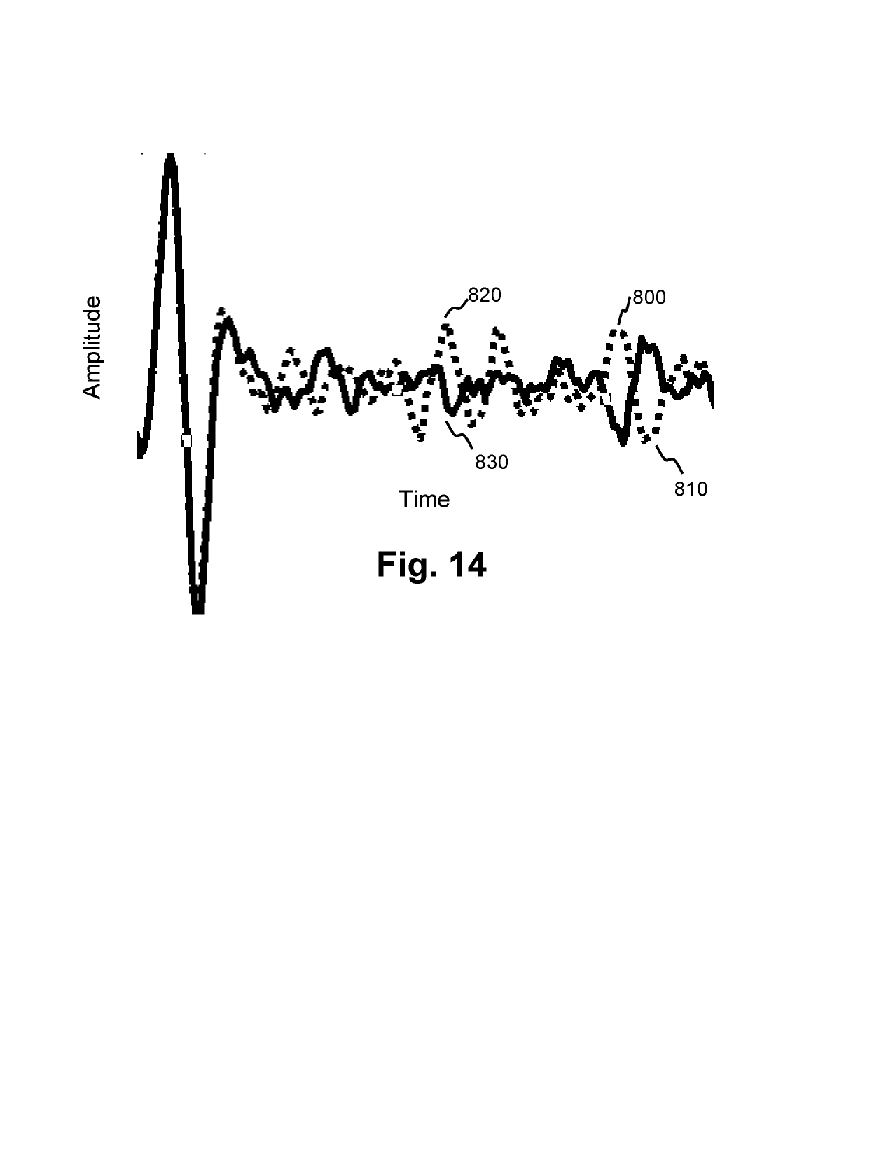

FIG. 14 shows an example of correlation waveforms relating to two seed values for the sequence generator showing partial side-lobe cancelation. Side lobe spurs 800 and 820 relating to two P-N generator seed values, exhibit inverse behaviors that when summed would cancel. Spurs 810 and 830 do not completely cancel, but as additional waveforms of differing seed values are added, a more consistent periodic side-lobe pattern develops, which is easier to distinguish from actual return correlative waveforms. An additional benefit of the rotating pattern is at high received signal-to-noise ratios, is it helps prevent flat spots in the distance measurement transfer function caused by minimal sampled waveform changes with small changes in delay. As the transmitted pattern changes due to differing seed values, the sampling points on the captured received signal change. Shifting sampling points occur due to slight changes in transmitted waveform over the duration of the pulse burst and differing baseline voltage offsets due to lower frequency received waveform shifts due to AC coupling of the receiver amplifier elements.

An additional benefit of rotating the transmitted pattern may be the reduction in the probability of crosstalk between multiple rangefinders illuminating at the same target. The matched filter behavior of the correlative process significantly reduces processing gain of patterns not matching the transmitted pattern. This situation can be encountered by Lidar systems used in crowded environments in automotive and general robotics applications.

Other embodiments may include the addition of a delay shifting element to randomly or periodically vary the effective received signal delay at the sampler input, moving the sampling point on the return waveform over a duration typically less than the input sampling interval. At high signal to noise ratios, to achieve high linearity in the distance measurement transfer function, a combination of received signal sampler delay modulation and rotating transmitted patterns can be used.

Embodiments of the present invention apply a memory-efficient configuration employing both correlation-based and analog-to-digital converter (ADC)-based methodologies within an FPGA implementation. This optimized memory strategy enables simultaneous computation of ranging solutions from both methods.

The FPGA system may simultaneously compute ranging solutions using both ADC-based and correlation-based methodologies. To enhance operational efficiency and accuracy, the FPGA may utilize preliminary ADC-based results to narrow the search window for valid correlation-based ranging solutions.

If a reliable correlation-based solution is determined, this method may be prioritized and reported as the primary measured range to the user, providing accuracy comparable to prior correlation-based implementations in many operating conditions. However, in scenarios where a definitive correlation-based solution is not available, the FPGA may default to providing the ADC-based ranging solution.

This hybrid implementation addresses challenges associated with multipath interference by concurrently processing return signals through both ADC-based and correlation-based ranging paths. By combining these methods, the system may leverage the high-accuracy benefits of correlation-based ranging at shorter distances—where beam divergence and target non-uniformity are minimal—while also maintaining extended range performance through the ADC processing path. This dual-path architecture enhances overall system robustness and may improve ranging reliability in complex environments. As an alternative embodiment, the correlation process itself may be performed directly on digitized samples obtained from the ADC as described above.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A laser rangefinder comprising:
an optical transmitter configured to emit a code-sequence-modulated optical burst along a transmission path toward a target, the optical burst being modulated according to a transmitted code sequence;
an optical receiver configured to receive a return optical signal reflected from the target and to convert the return optical signal into an analog receive signal;
a delta modulator coupled to the optical receiver and configured to sample the analog receive signal at successive sample points and to output a succession of logic output states, each logic output state representing a sign of a difference in magnitude between the analog receive signal at a respective sample point and the analog receive signal at a preceding sample point;
a sampler coupled to an output of the delta modulator and configured to capture the succession of logic output states in timed relation to a clock reference to produce a slope-decoded signal record; and
a processor coupled to the sampler and configured to:
correlate the slope-decoded signal record with a stored reference sequence corresponding to the transmitted code sequence to produce a correlation function representing a derivative of a delayed autocorrelation of the return optical signal,
identify a zero-crossing point of the correlation function following a peak of the correlation function, and
determine a range to the target based at least in part on a time delay associated with the zero-crossing point.

2. The laser rangefinder of claim 1, wherein the delta modulator includes:
a non-inverting input configured to receive the analog receive signal; and
an inverting input configured to receive the analog receive signal through a delay element providing approximately one sampling interval of delay.

3. The laser rangefinder of claim 2, wherein the delta modulator further comprises a summing node configured to receive a direct-current offset signal that centers a differencing threshold within a noise envelope of the analog receive signal.

4. The laser rangefinder of claim 1, wherein the delta modulator comprises a first and a second sample-and-hold alternately enabled to capture the analog receive signal.

5. The laser rangefinder of claim 1, wherein the delta modulator comprises first and second comparators having detection thresholds offset respectively above and below a zero-slope baseline.

6. The laser rangefinder of claim 1, further comprising a delay-shifting element between the optical receiver and the sampler that varies a delay applied to the analog receive signal by an amount less than one sampling interval across successive acquisitions.

7. The laser rangefinder of claim 1, wherein each logic output state further represents a magnitude of the difference in addition to the sign of the difference.

8. The laser rangefinder of claim 1, wherein the processor is further configured to interpolate the zero-crossing point between adjacent samples of the correlation function to achieve a range resolution finer than the sampling interval.

9. A laser rangefinder comprising:
an optical transmitter configured to emit a code-sequence-modulated optical burst along a transmission path toward a target, the optical burst being modulated according to a transmitted code sequence;
an optical receiver configured to receive a return optical signal reflected from the target and to convert the return optical signal into an analog receive signal;
a delta modulator coupled to the optical receiver and configured to sample the analog receive signal at successive sample points and to output a succession of logic output states, each logic output state representing a sign of a difference in magnitude between the analog receive signal at a respective sample point and the analog receive signal at a preceding sample point;
a sampler coupled to an output of the delta modulator and configured to capture the succession of logic output states in timed relation to a clock reference to produce a slope-decoded signal record; and
a processor coupled to the sampler and configured to:
correlate the slope-decoded signal record with a stored reference sequence corresponding to the transmitted code sequence to produce a correlation function representing a derivative of a delayed autocorrelation of the return optical signal,
identify a zero-crossing point of the correlation function following a peak of the correlation function,
determine a range to the target based at least in part on a time delay associated with the zero-crossing point,
compute an analog-to-digital converter-based range measurement from digitized samples of the analog receive signal in parallel with the correlation,
use the analog-to-digital converter-based range measurement to define a search window for the zero-crossing point, and
report the range derived from the zero-crossing point when a correlation-based solution is determined and otherwise report the analog-to-digital converter-based range measurement.

10. The laser rangefinder of claim 9, wherein the delta modulator includes:
a non-inverting input configured to receive the analog receive signal; and
an inverting input configured to receive the analog receive signal through a delay element providing approximately one sampling interval of delay.

11. The laser rangefinder of claim 10, wherein the delta modulator further comprises a summing node configured to receive a direct-current offset signal that centers a differencing threshold within a noise envelope of the analog receive signal.

12. The laser rangefinder of claim 9, wherein the delta modulator comprises a first and a second sample-and-hold alternately enabled to capture the analog receive signal.

13. The laser rangefinder of claim 9, wherein the delta modulator comprises first and second comparators having detection thresholds offset respectively above and below a zero-slope baseline.

14. A laser rangefinder comprising:
an optical transmitter configured to emit a code-sequence-modulated optical burst along a transmission path toward a target, the optical burst being modulated according to a transmitted code sequence;
an optical receiver configured to receive a return optical signal reflected from the target and to convert the return optical signal into an analog receive signal;
a delta modulator coupled to the optical receiver and configured to sample the analog receive signal at successive sample points and to output a succession of logic output states, each logic output state representing a sign of a difference in magnitude between the analog receive signal at a respective sample point and the analog receive signal at a preceding sample point, the delta modulator including:
a non-inverting input configured to receive the analog receive signal; and
an inverting input configured to receive the analog receive signal through a delay element providing approximately one sampling interval of delay;
a sampler coupled to an output of the delta modulator and configured to capture the succession of logic output states in timed relation to a clock reference to produce a slope-decoded signal record; and
a processor coupled to the sampler and configured to:
correlate the slope-decoded signal record with a stored reference sequence corresponding to the transmitted code sequence to produce a correlation function representing a derivative of a delayed autocorrelation of the return optical signal,
identify a zero-crossing point of the correlation function following a peak of the correlation function, and
determine a range to the target based at least in part on a time delay associated with the zero-crossing point.

15. The laser rangefinder of claim 14, wherein the delta modulator further comprises a summing node configured to receive a direct-current offset signal that centers a differencing threshold within a noise envelope of the analog receive signal.

16. The laser rangefinder of claim 14, wherein the delta modulator comprises a first and a second sample-and-hold alternately enabled to capture the analog receive signal.

17. The laser rangefinder of claim 14, wherein the delta modulator comprises first and second comparators having detection thresholds offset respectively above and below a zero-slope baseline.

18. The laser rangefinder of claim 14, further comprising a delay-shifting element between the optical receiver and the sampler that varies a delay applied to the analog receive signal by an amount less than one sampling interval across successive acquisitions.

19. The laser rangefinder of claim 14, wherein each logic output state further represents a magnitude of the difference in addition to the sign of the difference.
